(19) United States
(12) Patent Application Publication
(10) Pub. No.: US 2026/0348466 A1
(43) Pub. Date: Nov. 5, 2026

(54) ELECTROMAGNETIC ACTUATOR AND TRANSMISSION SYSTEM EQUIPPED WITH SUCH AN ACTUATOR

(71) Applicant: VALEO EMBRAYAGES, Amiens (FR)

(72) Inventors: Fabien DIASCORN, Amiens (FR); Christophe MOLLIER, Amiens (FR); Jean Noel GILLION, Creteil Cedex (FR); Ratheesh Kumar SEMBA, Chennai (IN)

(73) Assignee: VALEO EMBRAYAGES, Amiens (FR)

(21) Appl. No.: 19/486,316

(22) PCT Filed: May 7, 2024
(86) PCT No.: PCT/EP2024/062629

§ 371 Date: Nov. 20, 2025

(30) Foreign Application Priority Data
May 23, 2023 (FR) FR2305049

(51) Int. Cl. F16H 48/34; F16H 48/08

(52) U.S. Cl. CPC F16H 48/34; F16H 48/08; F16H 2048/087; F16H 2048/346

(57) ABSTRACT

An electromagnetic actuator for a transmission system includes a base and an outer casing defining a hollow receiving portion, a solenoid placed inside the receiving portion, and a closure cover fitted on the base so as to form an annular opening in the receiving portion, the closure cover covering one of the lateral faces of the solenoid. A piston which has a cylindrical shape and comprises a piston body and a push part, which is axially movable within the receiving portion between a retracted position and an extended position in which the piston body bears against the closure cover and the push part passes through the annular opening.

### TECHNICAL FIELD

The invention relates to the field of drivetrains for vehicles.

It relates more particularly to an electromagnetic actuator for a transmission system and to the transmission system equipped with such an actuator.

The invention also relates to a transmission system of the differential type which is intended to transmit and distribute torque coming from a motor/engine to two half-shafts of an axle of the vehicle. The transmission system comprises a first element intended to be driven by a motor/engine, a second element intended to drive at least one half-shaft of a vehicle, a coupling device able selectively to couple the first element to the second element, and said electromagnetic actuator for controlling the coupling device.

### TECHNOLOGICAL BACKGROUND

Document DE102013111891 A1 discloses a transmission system of the differential type. The transmission system comprises a differential casing which is movable in rotation about an axis A and is equipped with a gear wheel driven by a motor/engine of the vehicle. Housed inside the casing there are a supporting ring guided in rotation in the casing, two planet pinions mounted with the ability to rotate on the supporting ring about an axis B perpendicular to the axis A, and two sun gears each of which meshes with the two planet pinions and each of which is secured, for conjoint rotation, to a half-shaft. Used on a motor vehicle, the transmission system of differential type allows the driving wheels to rotate at different speeds when cornering: the wheels located on the outside of the corner rotate more quickly than those located on the inside.

Moreover, the transmission system comprises a coupling device that can be used either to couple the casing of the transmission system to the supporting ring so as to transmit and distribute the torque from the motor/engine to the two half-shafts of the axle, or to uncouple them so as to interrupt the transmission of torque between the motor/engine and the half-shafts. The coupling device is a claw-type coupling device. It comprises a first coupling part having an annular part arranged on the outside of the casing, and projecting elements which extend from the annular part and pass through orifices formed in the casing, thereby enabling the first coupling part and the casing to be secured against rotation. The second coupling part of the coupling device comprises the supporting ring. The projecting elements comprise toothsets which are intended to engage with complementary slots formed on the supporting ring. The first coupling part is axially mobile with respect to the casing between an uncoupled position and a coupled position in which the toothsets of the first coupling part engage with the slots of the supporting ring.

An electromagnetic actuator is able to apply axial force to the first coupling part so as to move it from the uncoupled position to the coupled position. The actuator comprises in particular a piston formed in two separate parts made of different materials: a piston body made of ferromagnetic material for reacting to the activity of the magnetic flux of the actuator, and a push part made of paramagnetic material for preventing magnetic flux from undesirably leaking out to other components of the transmission system. Such an electromagnetic actuator is not entirely satisfactory because it requires the use of expensive and rare material, which increases its complexity and cost.

Furthermore, the transmission system has an annular target which is axially fixed to the annular part of the first coupling portion. The annular target is positioned axially facing a sensor, such as a Hall effect sensor, which outputs a signal representative of an axial distance between the sensor and the annular target.

The transmission system further comprises an elastic washer which is positioned axially between the annular target and the casing. The function of this elastic washer is in particular to exert a return force on the first coupling part so as to return it to its uncoupled position when the electromagnetic actuator no longer exerts force on the first coupling part.

Such a transmission system is not entirely satisfactory because it has many different component parts, in particular for performing the functions of the target and of returning the coupling device to its uncoupled position, thereby increasing its complexity and size.

### SUMMARY

An idea on which the invention is based is to provide an electromagnetic actuator that does not require the use of paramagnetic material to prevent magnetic flux from undesirably leaking out to other components of the transmission system, this actuator being more straightforward to manufacture.

The invention aims to overcome this problem by providing an electromagnetic actuator for a transmission system, comprising:
a base and an outer casing defining a hollow receiving portion;
a solenoid placed inside the receiving portion;
a closure cover fitted on the base so as to form an annular opening in the receiving portion, said closure cover covering one of the lateral faces of the solenoid;
a piston which has a shape exhibiting symmetry of revolution about a main axis X and comprises a piston body and a push part, which is axially movable within the receiving portion between a retracted position and an extended position in which the piston body bears against the closure cover and the push part passes through the annular opening, the electromagnetic actuator being notable in that the piston, produced in one piece from a ferromagnetic material, surrounds the solenoid and has a stop surface which defines an air gap with the closure cover, said stop surface being frustoconical or partially spherical.

This electromagnetic actuator with its piston, produced in one piece from a ferromagnetic material such as steel, has the advantage of being more responsive than a piston made partially from a paramagnetic material such as brass, which has a higher density. The one-piece piston is therefore more lightweight.

The base can be produced in multiple parts, for example an inner tube fitted with a closure plate. In this case, the inner tube, the closure plate and the outer casing define the hollow receiving portion.

Advantageously, the closure cover may have a stop face complementing the stop surface of the piston, of respective frustoconical or partially spherical shape, the air gap being formed between the stop surface of the piston and the stop face of the closure cover. According to one variant, the frustoconical surface of the piston and the complementary frustoconical surface of the closure cover have similar angles. According to another variant, the frustoconical surface of the piston and the complementary frustoconical surface of the closure cover have different angles. This avoids the effect of the two surfaces adhering to one another. More generally, the invention aims to protect any type of geometry for which the stop surface and the stop face are not perpendicular to the main axis X.

With preference, the air gap can be located on a diameter greater than the outside diameter of the solenoid. The particular geometry of the piston and of the closure cover thus limits undesirable leaks of magnetic flux out of the actuator. For example, the air gap is defined by the outside diameter of the closure cover.

Advantageously, the push part of the piston can comprise an outer flange extending radially from the piston body, the outer flange being located outside the receiving portion of the electromagnetic actuator.

With preference, the outer flange can form an end stop with the outer casing of the receiving portion when the piston is in its retracted position. The particular geometry of the push part defines a stable retracted position for the piston.

Advantageously, the push part of the piston may have a bearing surface arranged to bear against a component of the transmission system. The bearing surface is perpendicular to the main axis X.

With preference, the bearing surface of the piston can have a surface treatment which makes it easier for it to slide. This limits the wear of the end of the piston, in particular when the other component slides circumferentially on the lateral bearing surface.

Advantageously, the closure cover may have a shoulder against which a shoulder of the piston body comes into abutment when the piston is in the extended position.

With preference, the piston body may comprise two cylindrical centering portions positioned facing the bore in the outer casing.

Another idea on which the invention is based is to provide a transmission system fitted with a coupling device, a target and a sensor which is able to output a signal representative of the state of the coupling device; this transmission system being simpler and/or smaller overall.

The invention, according to another of its aspects, aims to overcome this problem by providing a transmission system for a motor vehicle, comprising:
a first element and a second element which are rotatable relative to one another about a main axis X, one of the first and second elements being intended to be driven by a motor/engine and the other of the first and second elements being intended to drive at least one half-shaft of the motor vehicle; and
a coupling device which comprises:
a first coupling part which is secured for conjoint rotation to the first element and a second coupling part which is secured for conjoint rotation to the second element, the first coupling part being axially movable relative to the first element between a coupled position in which the first coupling part is coupled to the second coupling part to transmit torque between the first element and the second element and an uncoupled position in which the first coupling part and the second coupling part are uncoupled from one another,
an elastic return device partially fixed to the first element and arranged to elastically deform as the first coupling part moves between the uncoupled position and the coupled position and to exert a return force able to elastically return the first coupling part to the uncoupled position or to the coupled position, said elastic return device having an actuation portion which is axially movable relative to the first element, and
the electromagnetic actuator incorporating all or some of the features mentioned above, wherein the piston bears axially against the actuation portion of the elastic return device.

Thus, the elastic return device provides the interface between the coupling device and the electromagnetic actuator and at the same time ensures the return of the first coupling part to its uncoupled position or to its coupled position. This makes it possible to reduce the cost, complexity and size of such a transmission system.

Advantageously, the elastic return device has a first fixing zone fixed to the first coupling part, a second fixing zone fixed to the first element and an elastic return portion connecting the first fixing zone to the second fixing zone.

According to one embodiment, the elastic return device may be an annular disk on the inner periphery of which there is the actuation portion, the disk being able to elastically deform between the actuation portion and the second fixing zone as the piston moves axially. In this embodiment, the actuation portion is contiguous with the first fixing zone.

According to a variant of this embodiment, the disk is made of spring steel, such as XC 70 steel, which is advantageously prehardened. The disk may have a thickness of between 0.4 and 1.2 mm, for example around 0.8 mm.

According to another variant of this embodiment, the disk is made of stainless steel, which is a non-magnetic metal, thereby also limiting undesirable leaks of magnetic flux.

With preference, the disk may be sized to generate a stiffness countering an axial movement of the piston toward the first coupling part which is comprised between 5 and 500 N/mm. The disk thus axially biases the piston, even when the latter is in its retracted position.

Advantageously, the disk can have a plurality of elastic return portions each made in the form of an elastic blade which connects the first fixing zone to the second fixing zone.

With preference, the actuation portion of the disk can be an inner annular portion which bears against the bearing surface of the piston. When the first coupling part is coupled to the second coupling part, the actuation portion slides along the bearing surface of the piston and when the first coupling part is uncoupled from the second coupling part, the actuation portion statically bears against the bearing surface of the piston.

Advantageously, the disk may have a target-forming outer annular portion which moves axially together with the actuation portion as the piston moves from its retracted position to its extended position.

In this embodiment, the transmission system may comprise a sensor which is positioned facing the outer annular portion of the disk and is configured to output a signal representative of a distance between the sensor and the target-forming annular portion.

Thus, the disc has dual functionality, specifically both to form the target of which the position is able to be detected by a sensor such that a signal is output indicating the position of the first part of the coupling device and to ensure the return of the first coupling part to its uncoupled position. This makes it possible to reduce the cost, complexity and size of such a transmission system.

According to another embodiment, the elastic return device may comprise a set of helical springs which are distributed circumferentially about the main axis X and form the elastic return portion.

According to another embodiment, the elastic return device may comprise a crinkle washer which extends circumferentially about the main axis X and forms the elastic return portion.

The transmission system according to the invention may have one or another of the features described below in combination with one another or independently of one another:
the sensor is positioned axially facing the annular portion of the disk.
as the first coupling part moves from the uncoupled position to the coupled position, the elastic return portion is under elastic load between a bearing zone of the transmission system and the fixing zone.
the bearing zone is axially fixed in place relative to the second coupling part.
each of the elastic blades has a free end.
the elastic blades bear against the bearing zone of the transmission system via the ends of the elastic blades.
each elastic blade is provided in a window formed in the disk.
the elastic blades are evenly distributed about the axis X so as not to create an unbalance.
the elastic blades are located radially on the inside of the target-forming annular portion, thereby limiting the radial size of the disk.
each elastic blade extends in a direction which has a circumferential component about the axis X. This makes it possible to obtain, for a given radial size, elastic blades of greater length and consequently of lower stiffness.
the first element comprises a differential case inside which the second coupling part is accommodated, the first coupling part comprising an annular part which is accommodated inside the case and a plurality of connecting studs which axially connect the annular part of the first coupling part to the disk, each of the connecting studs passing through a corresponding opening made in the case.
the disk is positioned outside the case and is fixed to the plurality of connecting studs of the first coupling portion.
the case has bosses projecting axially toward the outside of the case in the direction of the disk, each boss having an end which forms bearing zones associated with the second fixing zone of the disk.
the bosses have an axial dimension greater than or equal to the travel of the first coupling part between the coupled position and the uncoupled position.
the first element is a differential case.
the second element comprises a supporting ring which is guided in rotation about the axis X inside the case, two planet pinions which are mounted to rotate on the supporting ring about a secondary axis Z perpendicular to the main axis X and two sun gears which are able to rotate about the main axis X, are each in mesh with the two planet pinions and are each intended to be secured, for conjoint rotation, to a half-shaft. Thus, the transmission system forms a differential allowing the half-shafts to rotate at different speeds.
the two planet pinions each have bevel gear teeth meshing with complementary bevel gear teeth belonging to the two sun gears.
the second coupling part of the coupling device is secured, for conjoint rotation, to the supporting ring with respect to the axis X. Thus, when the coupling device is in the coupled position, the transmission system distributes the torque from the motor/engine to the two half-shafts. Conversely, the transmission of torque between the case and the supporting ring is interrupted when the coupling device is in the uncoupled position.
the second coupling part of the coupling device is formed in one piece with the supporting ring.
the second coupling part is secured, for conjoint rotation, to one of the sun gears. In such an embodiment, when the second coupling part is in the coupled position, torque is transmitted between the first element and the second element via the gearsets, but the differential function is locked by the coupling device, thereby preventing the half-shafts from rotating at different speeds.

According to one embodiment of the invention, the coupling device is a claw-type device, one of the first and second coupling parts comprising teeth and the other comprising corresponding slots into which said teeth engage when the first coupling part is in the coupled position.

According to another embodiment of the invention, the coupling device is a disconnection device able selectively to interrupt the transmission of torque between the first element and the second element.

According to another of its aspects, the invention also relates to a motor vehicle and to a transmission system incorporating all or some of the features mentioned above.

Advantageously, the motor vehicle comprises an electric machine and the first element of the transmission system is able to be driven by the electric machine.

The electric machine and the transmission system can be integrated in an electric axle.

Further features and advantages of the invention are revealed by the following description of non-limiting exemplary embodiments of the various aspects of the invention.

### BRIEF DESCRIPTION OF THE FIGURES

The invention will be better understood, and other aims, details, features and advantages thereof will become more clearly apparent over the course of the following description of several particular embodiments of the invention, given solely by way of non-limiting illustration, with reference to the appended drawings.

FIG. 1 is an overview, in cross section, of a transmission system fitted with an electromagnetic actuator according to a first embodiment.

FIG. 2 is an isometric view of the transmission system in FIG. 1.

FIG. 3 is a view of a detail of the electromagnetic actuator in the retracted position in FIG. 1.

FIG. 4 is an isometric view of the piston of the electromagnetic actuator in FIG. 1.

### DESCRIPTION OF THE EMBODIMENTS

In the description and the claims, the terms “outer” and “inner” and the orientations “axial” and “radial” will be used to denote elements of the transmission system according to the definitions given in the description. By convention, the “radial” orientation is orthogonal to the main axis X of rotation of the transmission system determining the “axial” orientation and, from the inside to the outside moving away from said axis, the “circumferential” orientation is orthogonal to the main axis X and orthogonal to the radial direction.

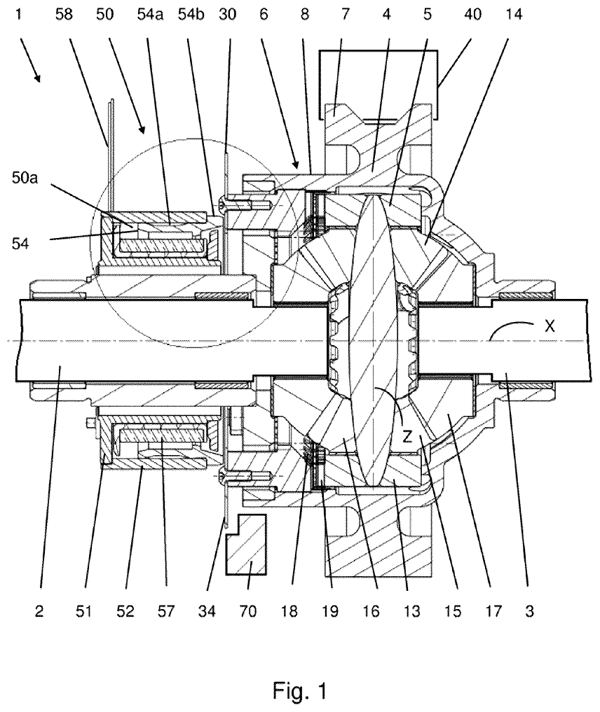

FIGS. 1 to 4 illustrate a transmission system 1 according to a first embodiment. The transmission system is in this case a differential which is used in a vehicle drivetrain to transmit and distribute torque originating from an internal combustion engine or an electric motor (not illustrated) to two half-shafts 2, 3 of an axle of a motor vehicle. Such a transmission system may, for example, form part of a secondary drivetrain capable of transmitting torque from a secondary motor/engine of the vehicle, such as an electric motor, to a rear or front axle of a vehicle, while a primary drivetrain is capable of transmitting torque from a main motor/engine, for example an internal combustion engine, to the half-shafts of another axle of the vehicle. According to other embodiments which have not been illustrated, the transmission system may also take some form other than that of a differential.

The transmission system comprises a first element 4 which is movable in rotation about the axis X and intended to be driven by a motor/engine, such as an electric motor (not shown); a second element 5 which is likewise movable in rotation about the main axis X and intended to drive the half-shafts 2, 3; and a coupling device 6 able selectively to couple or decouple the first element 4 and the second element 5.

The first element 4 comprises a gear wheel 7 which is intended to be driven by the motor/engine via a reduction gearset 40, which is shown schematically here. This first element 4 also comprises a case 8 which is secured, for conjoint rotation, to the gear wheel 7. Here, the case 8 is illustrated in one piece, but it could be made up of several component parts fixed to one another.

The second element 5 comprises an annular supporting ring 13 that is guided in rotation, about the main axis X, inside the case 8. To this end, the case 8 comprises an inner cylindrical portion cooperating with a cylindrical outer surface of the supporting ring 13 in order to guide it in rotation relative to the case 8. The second element 5 further comprises two planet pinions 14, 15, visible in FIG. 1, which are mounted with the ability to rotate on the supporting ring 13 about a secondary axis Z perpendicular to the main axis X. The two planet pinions 14, 15 each have bevel gear teeth which mesh with complementing bevel gear teeth of the two sun gears 16, 17. The two sun gears 16, 17 are rotatable about the main axis X and are each secured, for conjoint rotation, to one of the two half-shafts 2, 3. The supporting ring 13, the planet pinions 14, 15 and the sun gears 16, 17 form a differential allowing the two half-shafts 2, 3 to rotate at different speeds.

Furthermore, the transmission system 1 comprises a coupling device 6 which, in the coupled position, allows torque to be transmitted between the first element 4 and one of the components of the second element 5, in this instance the supporting ring 13. Thus, when the coupling device 6 is in the coupled position, the transmission system allows torque to be transmitted between the motor/engine and the half-shafts 2, 3, while performing a differential function to allow the half-shafts 2, 3 to rotate at different speeds.

The coupling device 6 comprises a first coupling part 18 which is secured, for conjoint rotation, to the case 8 while still being movable axially along the main axis X relative to said case 8. The first coupling part 18 is movable between an uncoupled position, shown in FIG. 1, and a coupled position. In the uncoupled position, the first coupling part 18 is uncoupled from a second coupling part 19 which is secured, for conjoint rotation, to the supporting ring 13 so that the transmission of torque between the case 8 and the supporting ring 13 is interrupted. By contrast, in the coupled position, the first coupling part 18 is coupled to the second coupling part 19, thereby allowing the transmission of torque between the case 8 and the supporting ring 13.

In the embodiment shown, the coupling device 6 is a claw-type coupling device. One of the first and second coupling parts 18, 19 thus comprises teeth while the other comprises corresponding slots in which said teeth engage when the first coupling part 18 is in the coupled position. In the embodiment shown, the second coupling part 19 is formed in one piece with the supporting ring 13. In other words, teeth or slots are formed in the lateral face of the supporting ring 13 that faces toward the first coupling part 18. However, although the invention has been described in connection with a claw-type coupling device, it is not restricted thereto, and the coupling device could be of another type and notably a friction coupling device.

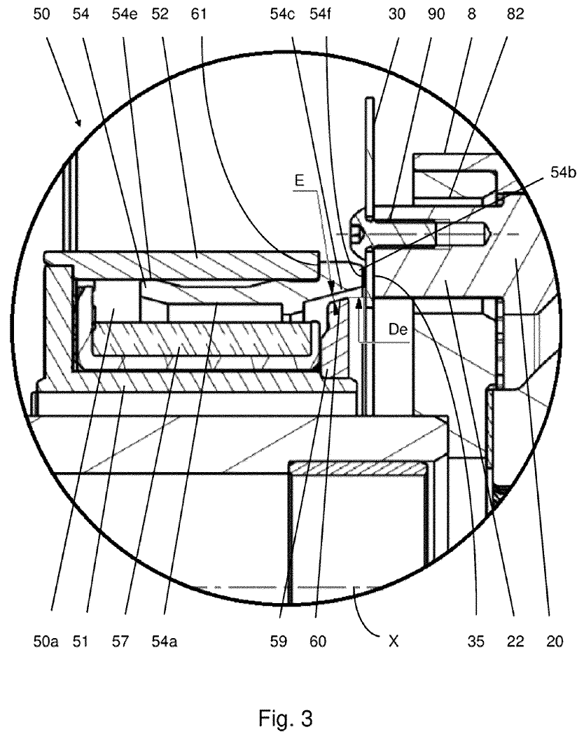

As shown in FIG. 3, the first coupling part 18 comprises an annular part 20 which is accommodated inside the case 8 and connecting studs 22 which are evenly distributed about the main axis X and each pass through a corresponding opening 82 formed in the case 8. The first coupling part 18 comprises an outer spline which is formed on the periphery of the annular part 20 and slides axially in an inner spline of the case 8. This makes it possible to secure the first coupling part 18 to the case 8 for rotation therewith while still allowing a relative axial movement between the first coupling part 18 and the case 8.

Furthermore, the transmission system 1 comprises an electromagnetic actuator 50, illustrated in greater detail in FIG. 3, for axially moving the first coupling part 18. The electromagnetic actuator 50 comprises a protective casing which is intended to be mounted on the chassis of the vehicle, fixedly in terms of rotation relative to the latter, by means of fixing elements (not illustrated). The protective casing comprises in particular a base 51 and an outer casing 52 defining a hollow receiving portion 50a.

The electromagnetic actuator 50 comprises a solenoid 57 and a piston 54 which is axially movable inside the receiving portion 50a between a retracted position, illustrated in FIG. 3, and an extended position. The solenoid can be a coil consisting of an electrical wire which is made of metal and evenly wound in a helix around a plastics support (for insulation). The outside diameter of the coil defines the outside diameter of the solenoid. In another variant of the invention, a soft iron core can be added to the solenoid 57 so as to form an electromagnet.

The electromagnetic actuator 50 also comprises a closure cover 59 fitted on the base 51 so as to form an annular opening in the receiving portion, said closure cover covering one of the lateral faces of the solenoid. The closure cover 59 closes the receiving portion 50a and has a stop face 60 for defining the extended position of the piston 54.

The piston 54, which has a shape exhibiting symmetry of revolution about the main axis X, comprises a piston body 54a and a push part 54b, which is axially movable within the receiving portion between a retracted position and an extended position in which the piston body 54a bears against the closure cover 59 and the push part passes through the annular opening.

According to the invention, the electromagnetic actuator is notable in that the piston 54, produced in one piece from a ferromagnetic material, surrounds the solenoid 57 and has a frustoconical stop surface 54c which defines an air gap E with the closure cover 59. The closure cover 59 also has a frustoconical stop face 60 complementing the stop surface 54c of the piston, the air gap E being formed between the two cone frustums of the piston and of the closure cover. In the embodiment illustrated in FIG. 3, the frustoconical stop surface 54c of the piston 54 and the frustoconical stop face 60 of the closure cover 59 have different angles. This avoids the effect of the two surfaces adhering to one another.

According to a variant embodiment of the invention (not shown), the stop surface 54c and the stop face 60 can be partially spherical, i.e. be a portion of the surface of a sphere comprised between two parallel planes which intersect this sphere, the two planes being perpendicular to the main axis X. More generally, the stop surface 54c and the stop face 60 are not perpendicular to the main axis X.

It should also be specified that the air gap E is located on a diameter De greater than the outside diameter of the solenoid 57. The particular geometry of the piston 54 and of the closure cover 59 thus limits undesirable leaks of magnetic flux out of the actuator. For example, the air gap E is defined by the outside diameter of the closure cover 59.

The electromagnetic actuator 50 is protected by the cylindrical outer casing 52 which has an axial rim 61 for defining the retracted position of the piston 54. The piston 54 bears against the axial rim 61 by way of an outer flange 54d positioned on the outer periphery of the piston.

When an alternating or direct current with a strength greater than a threshold strength flows through the solenoid 57 via the electrical connection 58, the solenoid generates a magnetic field around it, the force exerted by the magnetic field allowing the piston 54 to move axially within the chamber between a retracted position and an extended position in which the piston bears against the closure cover. The annular opening, formed by the closure cover 59, in the receiving portion tends to create an electromagnetic leak which attracts the piston 54. The piston 54 then moves axially until it comes into abutment against the closure cover 59. This defines the extended position.

When the piston is in the extended position, the closure cover 59 exerts an attraction on the piston body 54a, enabling it to be held in the extended position. The strength of the current with which the electromagnet 57 is powered can then be reduced so long as it remains above said threshold strength. When the electromagnet 57 is de-energized or when the strength of the current with which it is powered is lower than the threshold strength, an elastic return device 30, described below, makes it possible to return the first coupling part 18 to the uncoupled position.

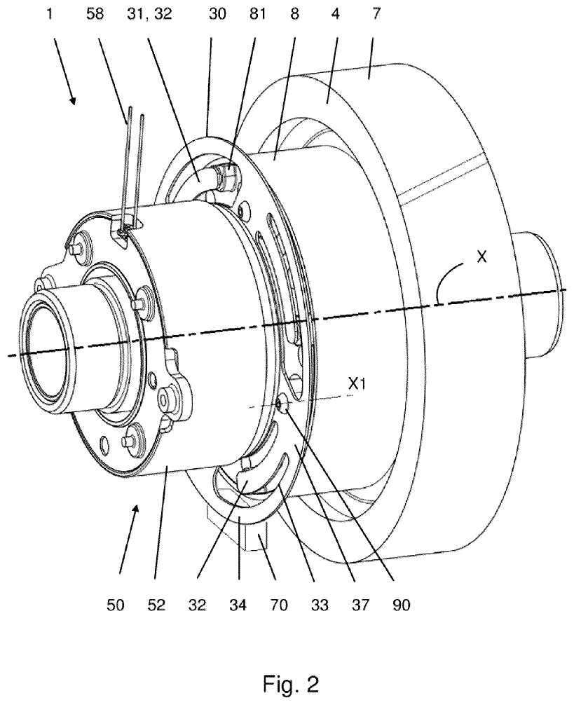

The elastic return device 30 is partially fixed to the first element 4 and is elastically deformed as the first coupling part 18 moves between the uncoupled position and the coupled position. Said elastic return device is produced in the present case in the form of a multifunctional disk 30, visible in FIG. 2, which is formed in one piece and is axially fixed to the first coupling part 18. The disk 30 has numerous functionalities described hereinbelow and thus helps to limit the cost, the complexity and the bulkiness of the coupling device 6.

The push part 54b has a bearing surface 54f arranged to bear against the disk 30 of the transmission system which transmits the actuating force to the first coupling part 18. The bearing surface 54f is perpendicular to the main axis X.

First of all, the disk 30 acts as a target 34 for evaluating the position of the piston 54. For this purpose, the disk comprises an annular portion 37 formed at the radially outer periphery of the disk 30. This outer annular portion 37 is positioned axially facing the sensor 70 and thus forms the target 34. The target 34 is axially fixed to the first coupling part 18. Furthermore, the coupling device 6 comprises a contactless sensor 70, shown in FIG. 1, which is positioned axially facing the target 34 and is configured to output a signal representative of the axial distance between the target 34 and the sensor 70. Thus, the sensor 70 is able to output a signal representative of the position of the first coupling part 18, such a signal being used to ensure the reliability of the command issued to the coupling device 6 and notably to verify that the coupling device 6 is indeed in the uncoupled position or in the coupled position. The sensor 70 is, for example, a Hall effect sensor.

Secondly, the disk 30 is able to transmit the actuating force between the piston 54 of the electromagnetic actuator 50 and the first coupling part 18. For this purpose, said elastic return device comprises an actuation portion 35 that can be moved axially relative to the first element 4. The piston 54 is in contact with an inner annular portion 35 of the disk 30 which defines the actuation portion.

Thirdly, the disk 30 acts as an elastic return means to enable the first coupling part 18 to be returned toward the uncoupled position when the piston 54 of the electromagnetic actuator 50 returns to the retracted position.

For this purpose, the disk 30 has a first fixing zone fixed to the first coupling part 18, a second fixing zone fixed to the first element 4 and an elastic return portion 31 connecting the first fixing zone to the second fixing zone. The annular disk 30 comprises the actuating portion 35 on its inner periphery and is elastically deformed between the actuation portion 35 and the second fixing zone as the piston 54 moves axially.

The disk 30 has a plurality of elastic return portions 31 each made in the form of an elastic blade which connects the first fixing zone to the second fixing zone. The elastic blades 31 each have a free end 32 that bears against a bearing zone of the case 8 and a proximal end connected to the rest of the disk 30. The elastic blades 31 are each formed in windows 33 positioned radially on the inside of the annular portion 37. The elastic blades 31 extend circumferentially about the main axis X, thereby making it possible to obtain, for a given radial size, elastic blades 31 of greater length and consequently of lower stiffness. As shown in FIG. 2, the free end 32 of the elastic blades 31 bears against the ends of bosses 81 projecting axially from the case 8 toward the disk 36. The extent to which the bosses 81 axially project is greater than the travel of the first coupling part 18 between the uncoupled position and the coupled position. The disk 30 comprises four elastic blades 31 in the embodiment shown.

The elastic blades 31 thus each form an elastic return portion which is configured to bend elastically as the first coupling part 18 moves from the uncoupled position toward the coupled position. In response to this, the elastic blades 31 apply a return force able to return said first coupling part 18 toward the uncoupled position.

Furthermore, the disk 30 is fixed to the first coupling part 18 via fixing screws 90.

By way of example, according to one embodiment, the disk 30 and more particularly the elastic blades 31 are sized to generate a stiffness K1 countering the axial movement of the first coupling part 18 toward the coupled position which is comprised between 5 and 500 N/mm, for example 50 N/mm.

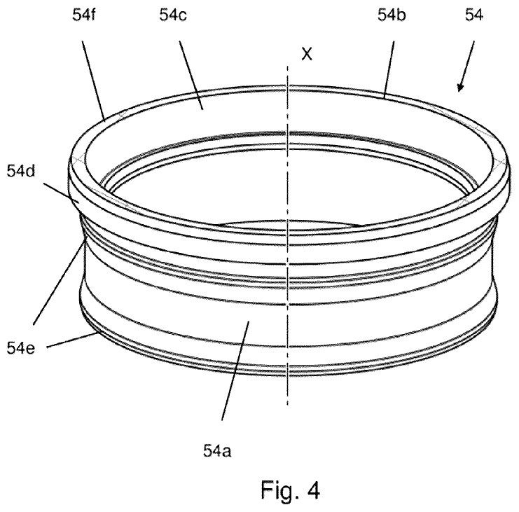

Fourthly, the disk 30 provides a sliding interface limiting the frictional forces brought about by the relative rotation of the disk 30, which is rotatable about the main axis X, relative to the piston 54, which for its part is fixed in terms of rotation. In particular, the push part 54b of the piston has a bearing surface 54f arranged to bear against the disk 30, as illustrated in FIG. 4. The bearing surface 54f of the piston 54 has a surface treatment which makes it easier for it to slide.

According to an advantageous variant, in order to even further limit the friction likely to be generated between the piston 54 and the disk 30, the actuating portion 35 of the disk 30 has, on its face facing toward the piston 54, a surface treatment which makes it easier for it to slide. For example, the surface treatment can be a treatment which involves incorporating carbon atoms on the surface of the disk. In a variant, the surface treatment may be a treatment based on polytetrafluoroethylene (PTFE).

The disk 30 is for example made of spring steel, such as XC 70 steel, which is advantageously prehardened. By way of example, the disk 30 has a thickness of between 0.4 and 1.2 mm, for example around 0.8 mm. Alternatively, the disk 30 is made of stainless steel.

This first embodiment of the invention illustrates the case in which the elastic return device 30 is arranged to elastically deform as the first coupling part moves from the uncoupled position to the coupled position and to exert a return force able to elastically return the first coupling part to the uncoupled position. In this first embodiment, the coupling device 6 is normally open, i.e. the first and second coupling parts 18, 19 are nested one in the other only when the electromagnetic actuator 50 is active, i.e. powered by current via the electrical connection 58. This first embodiment makes it possible to reduce the cost, complexity and size of the transmission system.

There is another embodiment, in which the elastic return device 30 is arranged to elastically deform as the first coupling part moves from the coupled position to the uncoupled position and to exert a return force able to elastically return the first coupling part to the coupled position. In this other embodiment, the coupling device 6 is normally closed, i.e. the first and second coupling parts 18, 19 are nested one in the other when the electromagnetic actuator 50 is inactive. The structure of the electromagnetic actuator 50 remains similar to the first embodiment but the piston 54 is oriented axially away from the case 8. Thus, the elastic return device 30 provides the interface between the coupling device 6 and the electromagnetic actuator and at the same time ensures the return of the first coupling part 18 to its coupled position.

Although the invention has been described in connection with a plurality of particular embodiments, it is obvious that it is in no way limited thereto and that it comprises all technical equivalents of the means described and combinations thereof where these fall within the scope of the invention as defined in the claims.

In the claims, any reference sign between parentheses should not be interpreted as limiting the claim.

1. An electromagnetic actuator for a transmission system, comprising:
a base and an outer casing defining a hollow receiving portion;
a solenoid placed inside the receiving portion;
a closure cover fitted on the base so as to form an annular opening in the receiving portion, said closure cover covering one of the lateral faces of the solenoid;
a piston which has a shape exhibiting symmetry of revolution about a main axis and comprises a piston body and a push part, which is axially movable within the receiving portion between a retracted position and an extended position in which the piston body bears against the closure cover and the push part passes through the annular opening;
wherein the piston, produced in one piece from a ferromagnetic material, surrounds the solenoid and has a stop surface which defines an air gap with the closure cover, said stop surface being frustoconical or partially spherical.

2. The electromagnetic actuator as claimed in claim 1, wherein the closure cover has a stop face complementing the stop surface of the piston, of respective frustoconical or partially spherical shape, the air gap being formed between the stop surface of the piston and the stop face of the closure cover.

3. The electromagnetic actuator as claimed in claim 2, wherein the air gap is located on a diameter greater than the outside diameter of the solenoid.

4. The electromagnetic actuator as claimed in claim 1, wherein the push portion of the piston comprises an outer flange extending radially from the piston body, the outer flange being located outside the receiving portion of the electromagnetic actuator.

5. The electromagnetic actuator as claimed in claim 4, wherein the outer flange forms an end stop with the outer casing of the receiving portion when the piston is in its retracted position.

6. The electromagnetic actuator as claimed in claim 1, wherein the piston body comprises two cylindrical centering portions positioned facing the bore in the outer casing.

7. The electromagnetic actuator as claimed in claim 1, wherein the push part of the piston has a bearing surface arranged to bear against a component of the transmission system.

8. The electromagnetic actuator as claimed in claim 7, wherein the bearing surface of the piston has a surface treatment which makes it easier for it to slide.

9. A transmission system for a motor vehicle, comprising:
a first element and a second element which are movable in rotation relative to one another about a main axis, one of the first and second elements being intended to be driven by a motor/engine and the other of the first and second elements being intended to drive at least one half-shaft of the motor vehicle; and
a coupling device which comprises:
a first coupling part which is secured for conjoint rotation to the first element and a second coupling part which is secured for conjoint rotation to the second element, the first coupling part being axially movable relative to the first element between a coupled position in which the first coupling part is coupled to the second coupling part to transmit torque between the first element and the second element and an uncoupled position in which the first coupling part and the second coupling part are uncoupled from one another,
an elastic return device partially fixed to the first element and arranged to elastically deform as the first coupling part moves between the uncoupled position and the coupled position and to exert a return force able to elastically return the first coupling part to the uncoupled position or to the coupled position, said elastic return device having an actuation portion which is axially movable relative to the first element, and
the electromagnetic actuator as claimed in claim 1, wherein the piston bears axially against the actuation portion of the elastic return device.

10. The transmission system as claimed in claim 9, wherein the elastic return device has a first fixing zone fixed to the first coupling part, a second fixing zone fixed to the first element and an elastic return portion connecting the first fixing zone to the second fixing zone.

11. The transmission system as claimed in claim 10, wherein the elastic return device is an annular disk on the inner periphery of which there is the actuation portion, the disk being able to elastically deform between the actuation portion and the second fixing zone as the piston moves axially.

12. The transmission system as claimed in claim 11, wherein the actuation portion of the disk is an inner annular portion which bears against the bearing surface of the piston.

13. The transmission system as claimed in claim 9, wherein the first element comprises a case inside which the second coupling part is accommodated, the first coupling part comprising an annular part which is accommodated inside the case and a plurality of connecting studs which axially connect the annular part of the first coupling part to the disk, each of the connecting studs passing through a corresponding opening made in the case.

14. The transmission system as claimed in claim 13, wherein the disk is positioned outside the case and is fixed to the plurality of connecting studs of the first coupling portion.

15. The transmission system as claimed in claim 9, wherein the second element comprises a supporting ring which is guided in rotation about the main axis inside the case, two planet pinions which are mounted to rotate on the supporting ring about a secondary axis perpendicular to the main axis, and two sun gears which are able to rotate about the main axis are each in mesh with the two planet pinions and are each intended to be secured, for conjoint rotation, to a half-shaft, and wherein the second coupling part of the coupling device is secured, for conjoint rotation, to the supporting ring with respect to the main axis.

16. The electromagnetic actuator as claimed in claim 2, wherein the push portion of the piston comprises an outer flange extending radially from the piston body, the outer flange being located outside the receiving portion of the electromagnetic actuator.

17. The electromagnetic actuator as claimed in claim 2, wherein the piston body comprises two cylindrical centering portions positioned facing the bore in the outer casing.

18. The electromagnetic actuator as claimed in claim 2, wherein the push part of the piston has a bearing surface arranged to bear against a component of the transmission system.

19. The transmission system as claimed in claim 10, wherein the first element comprises a case inside which the second coupling part is accommodated, the first coupling part comprising an annular part which is accommodated inside the case and a plurality of connecting studs which axially connect the annular part of the first coupling part to the disk, each of the connecting studs passing through a corresponding opening made in the case.

20. The transmission system as claimed in claim 10, wherein the second element comprises a supporting ring which is guided in rotation about the main axis inside the case, two planet pinions which are mounted to rotate on the supporting ring about a secondary axis perpendicular to the main axis, and two sun gears which are able to rotate about the main axis, are each in mesh with the two planet pinions and are each intended to be secured, for conjoint rotation, to a half-shaft, and wherein the second coupling part of the coupling device is secured, for conjoint rotation, to the supporting ring with respect to the main axis.
